(19) United States
(12) Patent Application Publication
(10) Pub. No.: US 2007/0062593 A1
(43) Pub. Date: Mar. 22, 2007

(54) V-RAD (vacuum-revolving automatic doser)

(76) Inventors: Andrew Arthur Morgan, Coopersburg, PA (US); Alan Edward Morgan, Quakertown, PA (US)

Correspondence Address: HYDRO INSTRUMENTS, 1501 WEST PARK AVE., P.O. BOX 213, PERKASIE, PA, 18944, US

(21) Appl. No.: 11/228,642

(22) Filed: Sep. 17, 2005

(51) Int. Cl. B01F 5/04

(52) U.S. Cl. 137/893

(57) ABSTRACT

The specific application initially contemplated for the V-RAD invention is that of feed rate control of liquid chemical solutions for the purpose of municipal and industrial water treatment. In this application, a vacuum solution feed system is commonly operated by water forced through a Venturi nozzle to create a vacuum that is used to draw the liquid chemical solution into the water. In the prior art, feed rate control has been achieved by employing a variable area orifice control valve. However, in the application of liquid chemical solution injection for industrial and municipal water treatment, the variable area orifice concept has proven to be severely limited in its ability to provide stable and accurate feed rate control. The V-RAD invention provides a new and unique method of feed rate control designed to replace the variable area orifice concept and to provide a stable and accurate method of feed rate control.

### BACKGROUND OF THE INVENTION

1. Field of Endeavor

Specifically, the invention was developed for the application of feed rate control of liquid solutions being injected into a water stream using a Venturi nozzle. The initially contemplated application is for feeding liquid chemical solutions in the field of municipal and industrial water treatment. The invention is more generally applicable to the field of accurate and consistent feed rate control of liquid solutions using an externally supplied pressure gradient.

2. Description of Specific Problems in Prior Art

Past feed rate control device designs for liquid solutions using Venturi nozzles are based on variable area orifices. The variable area orifice concept encounters several reliability limitations in the application of feeding liquid chemical solutions for municipal and industrial water treatment. These problems are outlined in the following paragraphs [0003] through [0007].

Problem #1—These variable area orifices are frequently subject to significant hysteresis.

Problem #2—The variable area orifices tend to experience both instability and gradual decline in feed rates (caused by fluctuations and decline in actual orifice area) due to two general sets of causes. In future discussions, they will be referred to individually as 2.a. and 2.b.

Problem #2.a.—The first cause of feed rate instability and decline is clogging by loose solids in the liquid solution as well as by precipitation of solids. Each cause the orifice area to be altered (generally area is reduced) thereby changing (primarily reducing) feed rate in an uncontrolled manner. NOTE: Filtration has been found to be unable to practically solve these problems in many cases because a clogged filter will also reduce feed rate and solids are also constantly crystallizing and precipitating out of many liquid chemical solutions.

Problem #2.b.—The second cause of feed rate instability and decline is mechanical instability of the orifice area.

Problem #3—As the feed rate is reduced (ie. as the orifice area is made smaller) all of these sets of problems become more severe. This is because the smaller the orifice area, the more likely it is to clog and the greater the percentage impact on orifice area for a given mechanical movement (mechanical instability or hysteresis effects feed rate more significantly as orifice area is reduced). NOTE: This is a critical factor because in the field of feeding liquid chemical solutions (such as Sodium Hypochlorite) into water for treatment of municipal or industrial water, the majority of systems require feed rates that are in the low range where these problems increase significantly. For example, from our experience these problems become unacceptable for feed rates below 1 gallon per hour for 12.5% Sodium Hypochlorite solution (the standard industrial strength solution) and a great number of systems feed below 1 gallon per hour.

### OBJECT OF THE INVENTION

To invent a device that will achieve accurate and stable control of liquid solution feed rate across a pressure gradient created by a Venturi nozzle. The device is to be designed to avoid hysteresis, mechanical instability, clogging by loose solids, and feed rate instability caused by precipitation of solids.

### GENERAL IDEA OF THE INVENTION

The invention consists of the implementation of the combination of two general design concepts to achieve the objective stated above. These two concepts are briefly described in paragraphs [0010] and [0011].

Design Concept 1: Feed rate control is effected by repeatedly adjusting the area of the orifice in a periodic manner. As time passes, the orifice area is continually cycled through a set of orifice sizes. One example of a cycle would be an ON/OFF cycle where OFF is zero feed rate (orifice area=zero) and ON is a fixed feed rate (orifice area=a constant greater than zero). In this example, the percentage of time in the ON position will be adjusted in order to adjust the feed rate.

Design Concept 2: The cycle is designed so that liquid solution flow direction through the orifice is reversed either during each cycle, in each consecutive cycle (as in the first V-RAD prototype device described in paragraphs [0046] through [0078]), or after any number of cycles has been completed to make it “self flushing”.

ADVANTAGES OF THE INVENTION AND HOW IT SOLVES THE PRIOR ART PROBLEMS—

In future discussions we refer to the prior art problems according the numbering used in the BACKGROUND OF THE INVENTION section (paragraphs [0003] through [0007]). The V-RAD invention design concepts outlined in paragraphs [0009] through [0011] work to overcome the problems of the prior art as will be explained in paragraphs [0013] through [0024].

Problem #1 (Hysteresis, paragraph [0003])—The hysteresis experienced in the prior art is caused by mechanical hysteresis in gears, threads, and/or the relative position of seat and stem. Since this invention uses the adjustment of the duration of time at a given orifice area value to adjust feed rate (Design Concept 1, paragraph [0010]) mechanical hysteresis is eliminated. This is because the mechanical motion can be designed to always remain uniform, while only the duration of time between motions is adjusted. The first V-RAD prototype described in DETAILED DESCRIPTION OF THE INVENTION (paragraphs [0033] through [0078]) has achieved this.

Problem #2.a. (Clogging and Precipitation of solids, paragraphs [0004] and [0005])—Design Concept 2 (paragraph [0011]) of the invention works to eliminate or greatly reduce this set of problems because it makes the device “self flushing”. Repeatedly and frequently reversing the liquid solution flow direction addresses both problems as is explained in paragraphs [0015] and [0016]:

Clogging (paragraph [0005]} The reversal of flow direction through the orifice allows loose particles to be transported through the device much like a revolving door without the need for the particles to travel through the actual orifice.

Precipitation of solids (paragraph [0005])—The reversal of flow direction through the orifice totally reverses the flow pattern and works to help erode away deposits of precipitates. Also, in the initially contemplated application of feed rate control with a Venturi nozzle feed system, the pressure on each side of the orifice will continually be changing from approximately atmospheric pressure to a high vacuum. The resulting turbulence will enhance the self-cleaning action.

Problem #2.b. (Mechanical Instability, paragraph [0006])—Using Design Concept 1 (paragraph [0010]) of the invention, the orifice can be designed to be immune to mechanical instability. The device can be designed so that normal mechanical instability will have no effect on orifice area. The first V-RAD prototype described in DETAILED DESCRIPTION OF THE INVENTION (paragraphs [0033] through [0078]) has achieved this.

Problem #3 (Low feed rate control, paragraph [0007])—In the prior art designs, problems 1, 2.a., and 2.b. are all increasingly aggravated as feed rate is reduced. The invention addresses each problem as is outlined in paragraphs [0020] through [0024]:

Problem #3:1.—Design Concept 1 (paragraph [0010]) allows for the elimination of hysteresis (prior art problem 1, paragraph [0003]) regardless of feed rate. The first V-RAD prototype described in DETAILED DESCRIPTION OF THE INVENTION (paragraphs [0033] through [0078]) has achieved this. Therefore, this problem is completely resolved by this invention.

Problem #3.2.a.—Design Concept 1 (paragraph [0010]) allows for substantial improvement at low feed rates compared to the prior art because it allows the use of a larger orifice for the same feed rate when compared to a variable area orifice control valve. Design Concept 2 (paragraph [0011]) also allows for dramatic reduction and in all but the most extreme cases, elimination of prior art problem 2.a for the following reasons outlined in paragraphs [0022] and [0023]:

First, clogging caused by loose solids can be virtually eliminated because the particles are transported past the orifice with each cycle of liquid solution flow direction reversal while in the prior art designs using variable area orifice control valves these particles would collect on the upstream side of the orifice.

Second, the action of cyclical liquid solution flow direction reversal and pressure (vacuum) fluctuations works to erode any deposits and represents a dramatic improvement over the prior art in this respect. In the prior art variable area orifice design, a slow moving steady flow pattern upstream of the orifice offers practically no impediment to the formation of deposits. NOTE: Precipitate deposition does depend partly on orifice material selection and so this must be taken into consideration in the same manner as in prior art orifice design.

Problem #3.2.b.—Design Concept 1 (paragraph [0010]) allows for the elimination of mechanical instability effects on feed rate (prior art problem 2.b.) regardless of feed rate. The first V-RAD prototype described in DETAILED DESCRIPTION OF THE INVENTION (paragraphs [0033] through [0078]) has achieved this. Therefore, this problem is completely resolved by this invention.

### BRIEF DESCRIPTION OF THE SEVERAL VIEWS OF THE DRAWINGS

### Prior Art FIGS.

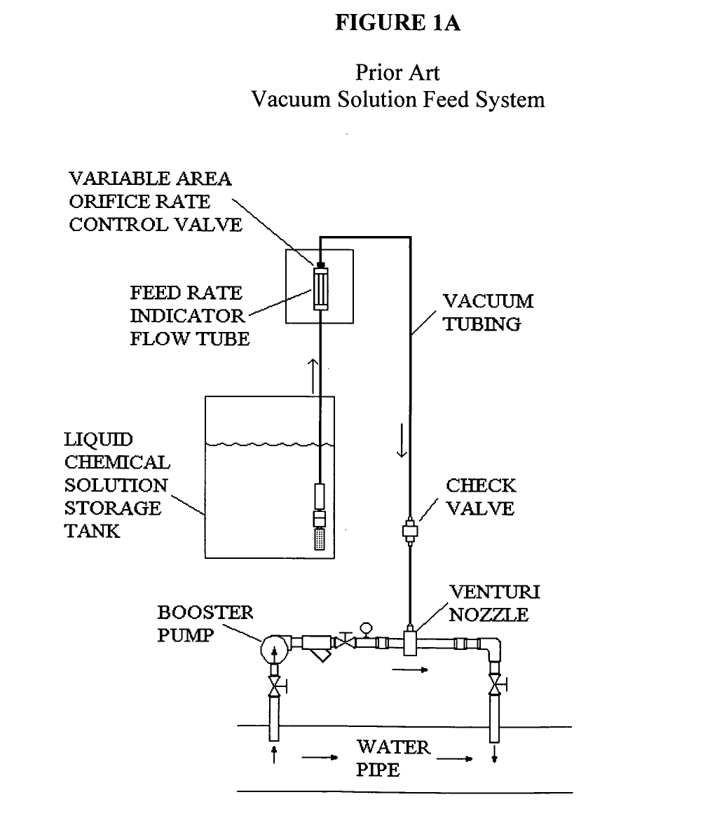

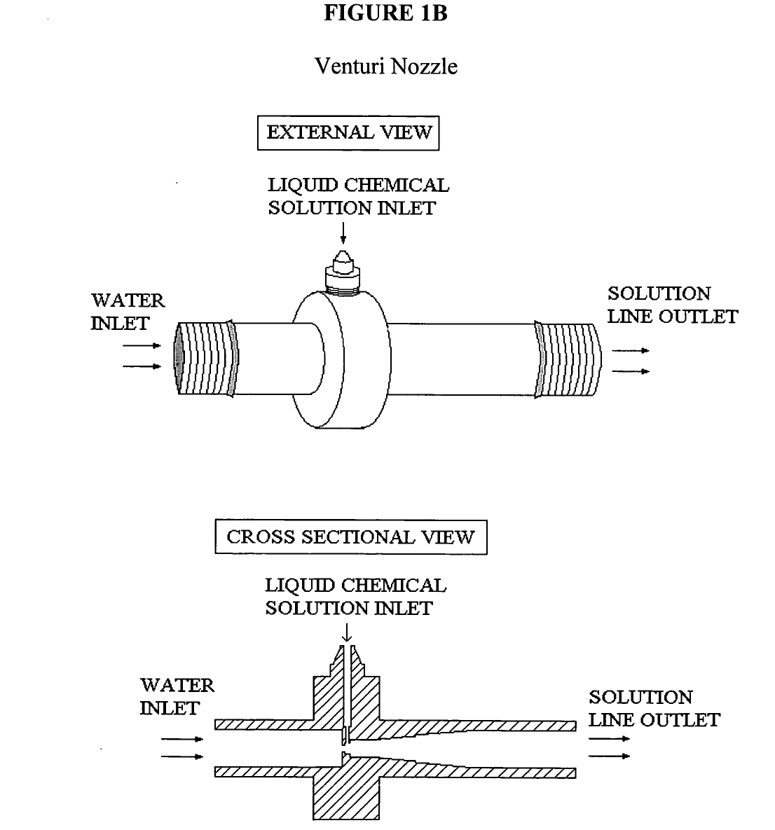

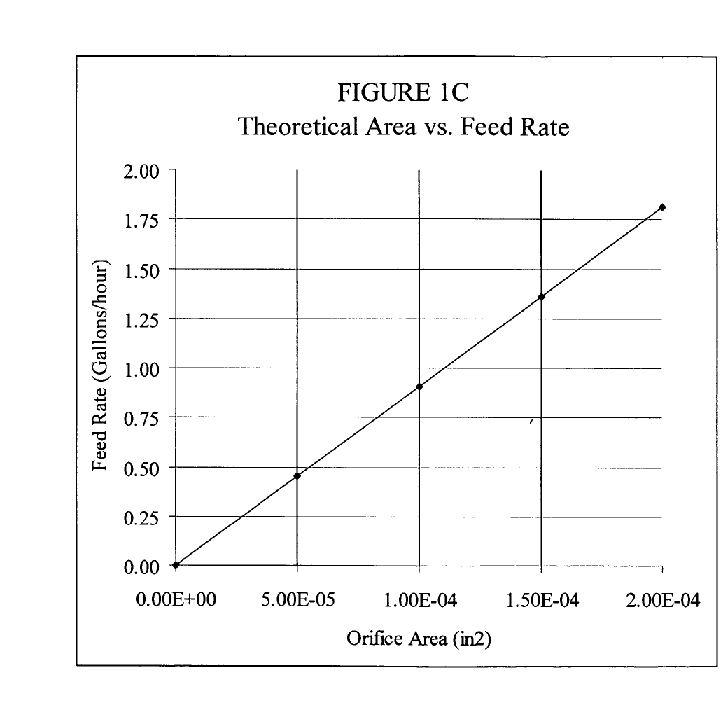

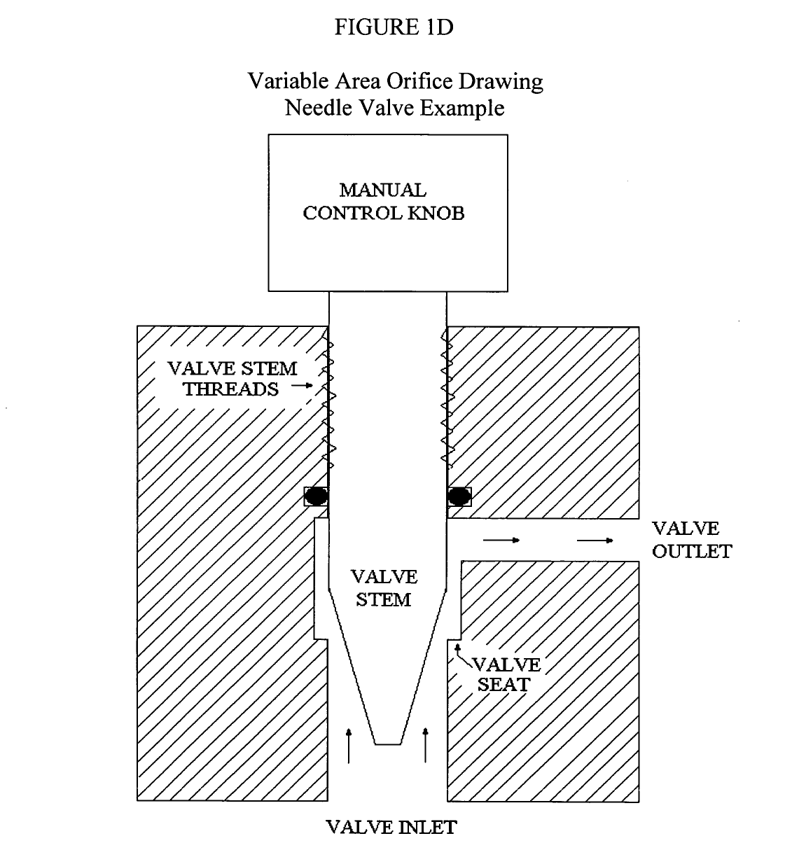

FIG. 1A—Prior Art System Design

FIG. 1B—Venturi Nozzle

FIG. 1C—Area vs. Feed Rate curve—Theoretical Performance Curve

FIG. 1D—Variable Area Orifice Control Valve—Needle Valve example

### V-Rad FIGS.

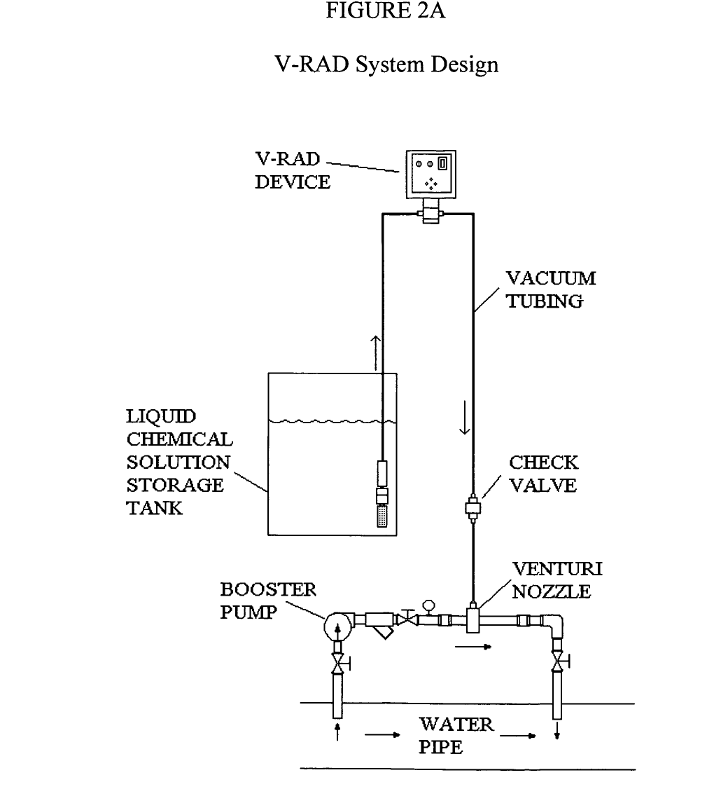

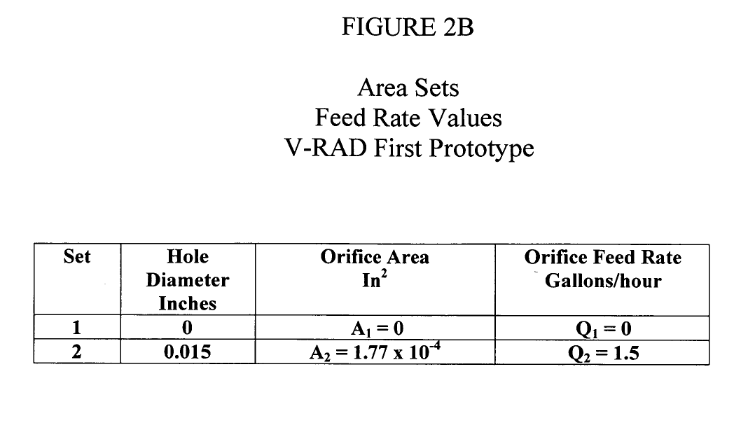

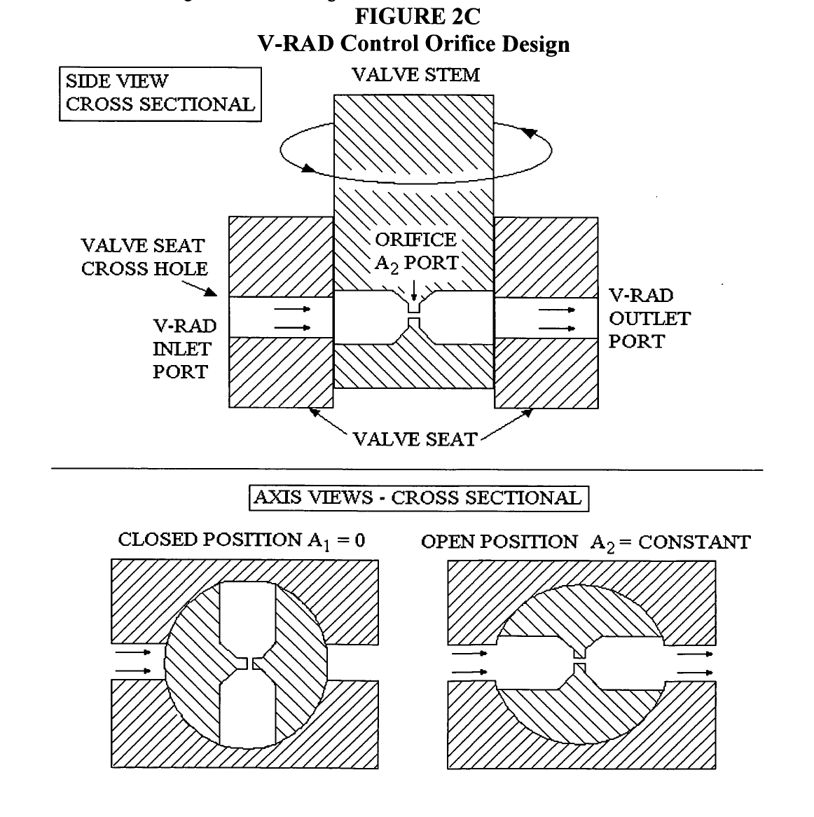

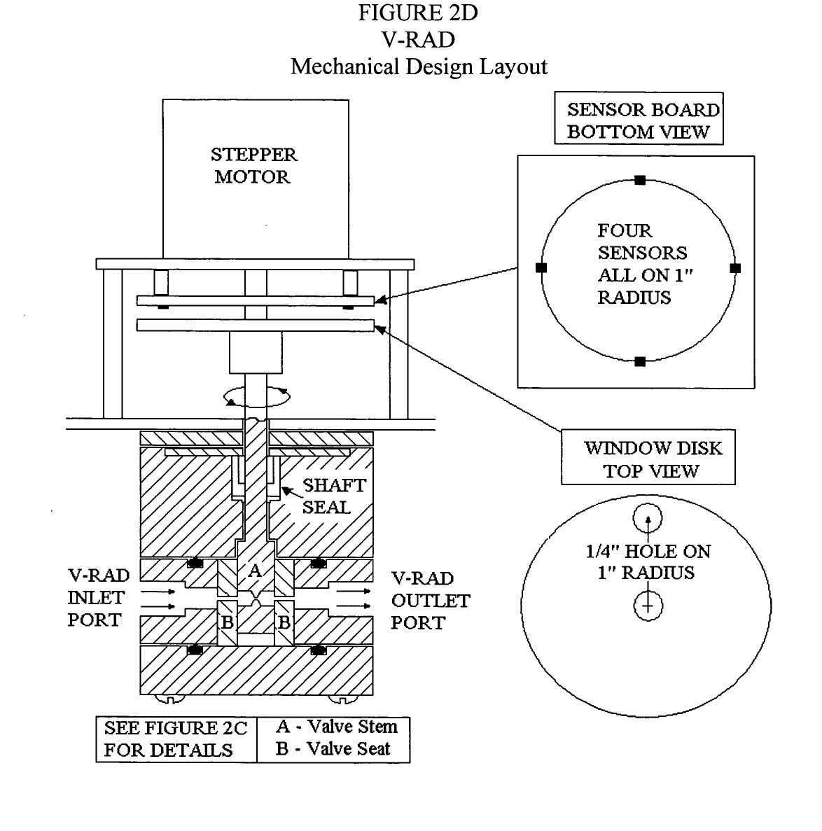

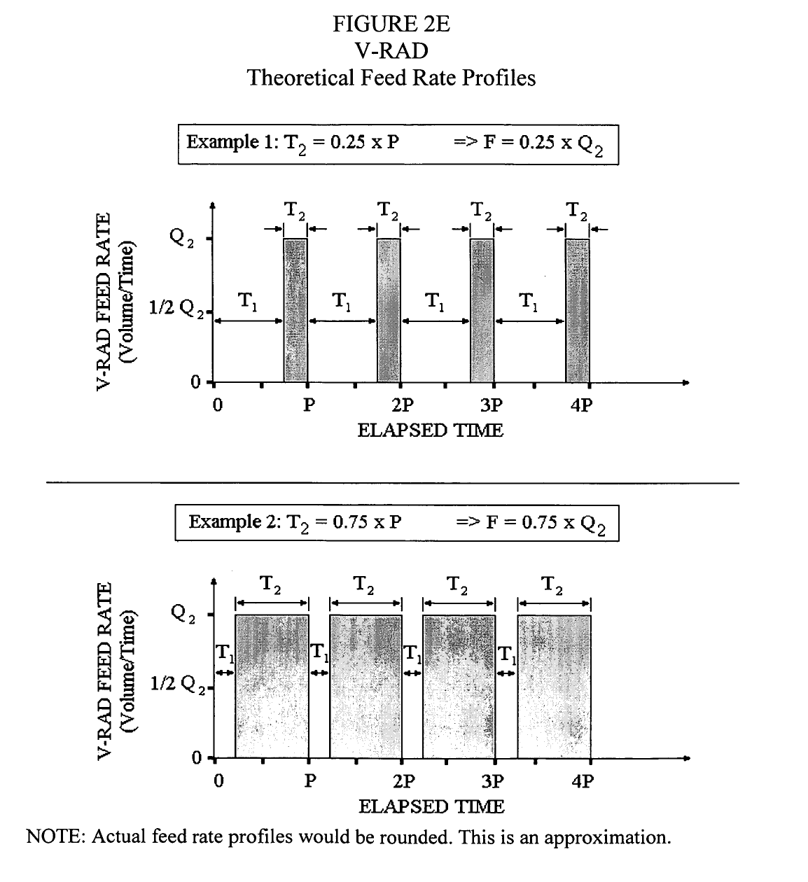

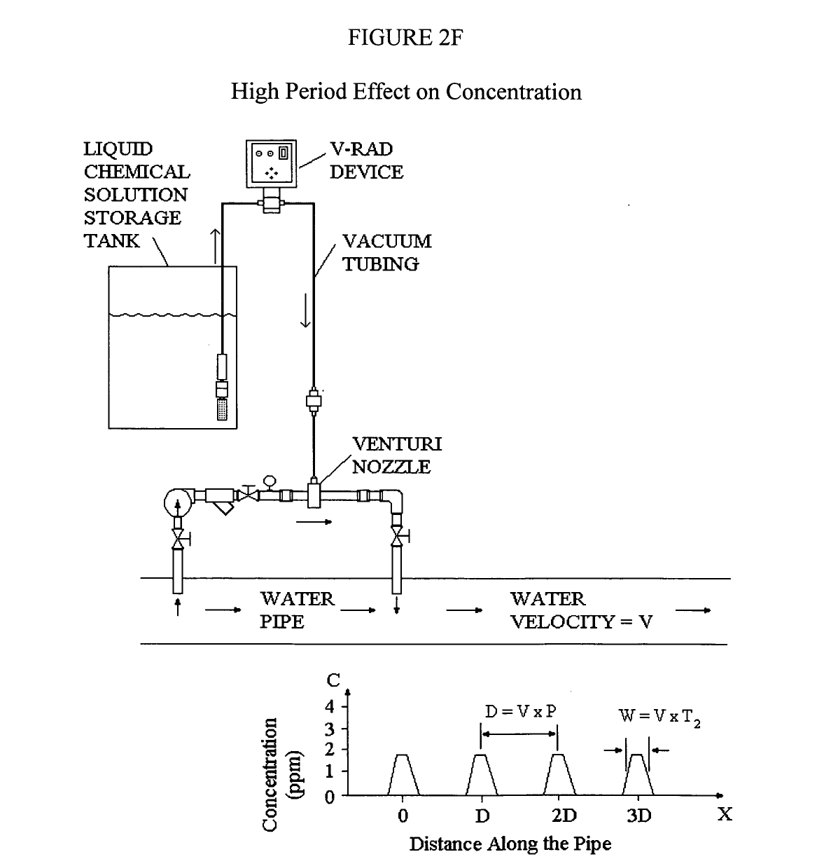

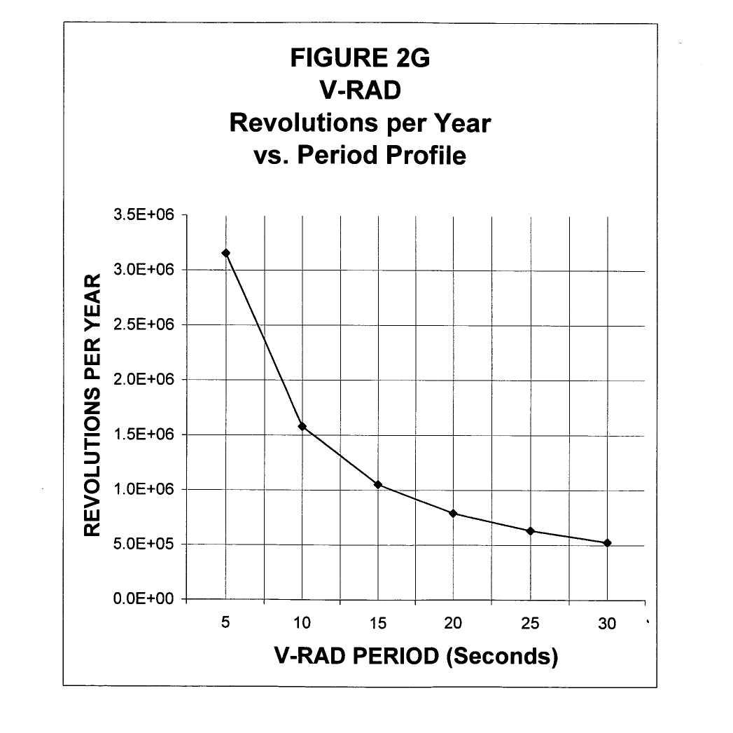

FIG. 2A—V-RAD System Design

FIG. 2B—Orifice Sets (Feed Rate Values)

FIG. 2C—V-RAD First Prototype Design Schematic of control orifice.

FIG. 2D—V-RAD First Prototype Mechanical Design Layout

FIG. 2E—V-RAD First Prototype Theoretical Feed Rate Profiles

FIG. 2F—V-RAD High Period Effect on Concentration

FIG. 2G—V-RAD Revolutions per year vs. Period Profile

### V-Rad Equations

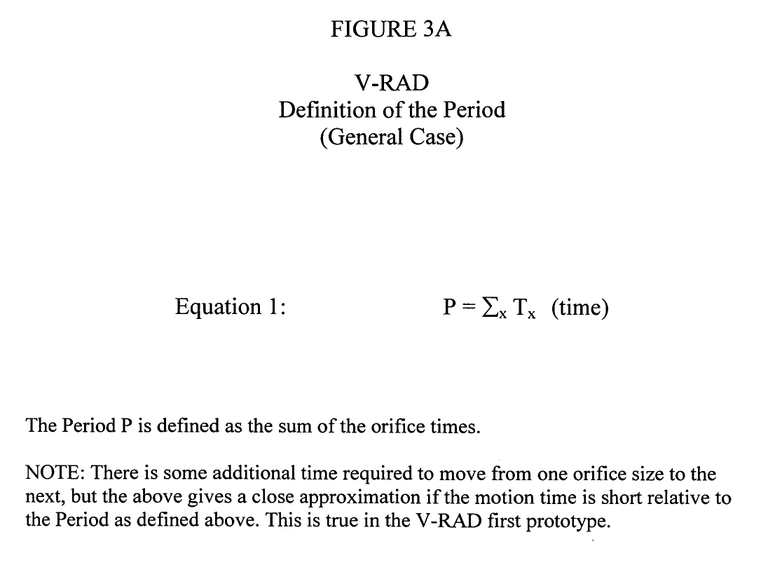

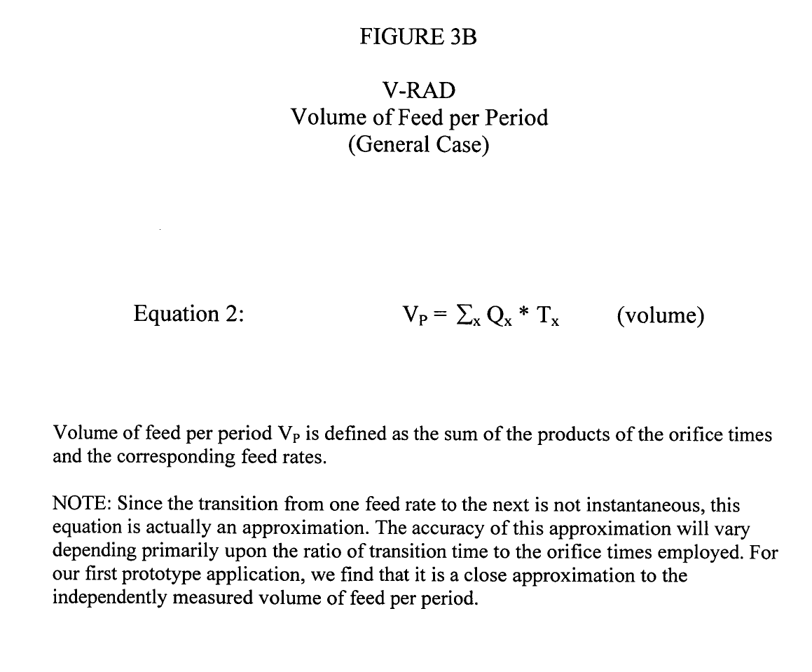

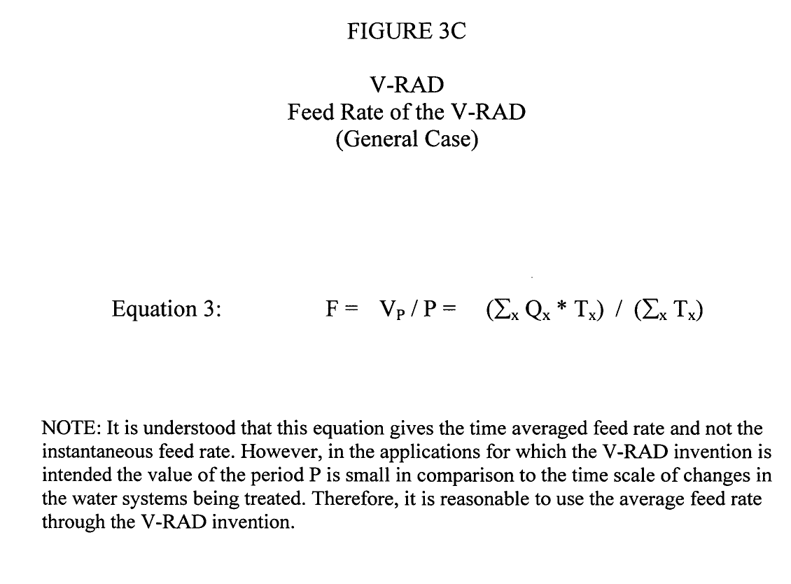

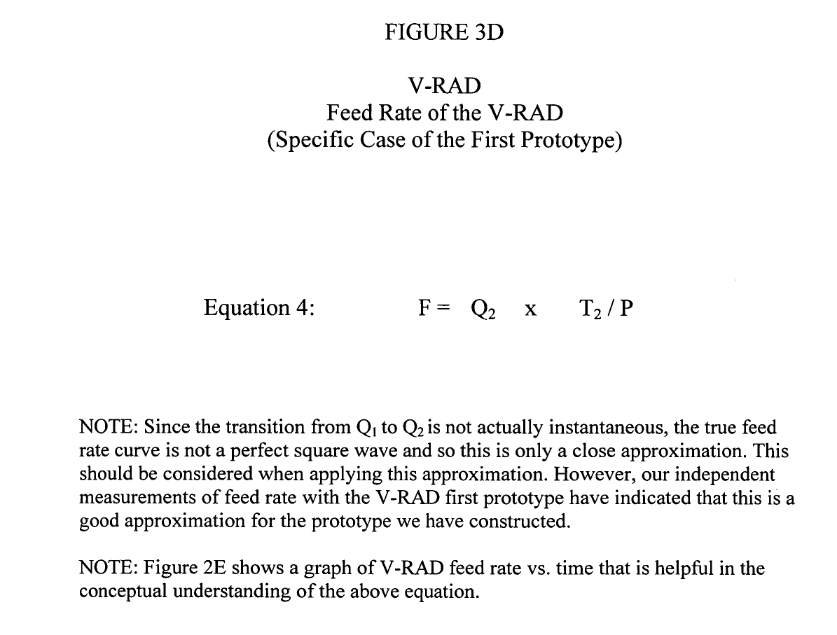

FIG. 3A—Equation #1—Definition of the Period (General Case)

FIG. 3B—Equation #2—Volume of Feed per Period (General Case)

FIG. 3C—Equation #3—Feed Rate of the V-RAD (General case)

FIG. 3D—Equation #4—Feed Rate of the V-RAD (Specific Case of the First Prototype)

### DETAILED DESCRIPTION OF THE INVENTION

Initial Intended Application of the Invention—The specific initially contemplated use is for feed rate control in municipal and industrial water treatment liquid chemical injection systems. More specifically, the V-RAD invention was developed for the application of feed rate control of liquid chemical solutions being injected into a water stream using a Venturi nozzle. In the municipal and industrial water treatment industry, such systems are often generally referred to as “Vacuum Solution Feed Systems”.

Design of Prior Art Systems—FIG. 1A shows the general layout of a prior art system design for injecting liquid solutions into a water stream. This prior art design is made up of two primary parts that will be described in paragraphs [0027] through [0031]:

Part 1—Venturi Nozzle—The Venturi nozzle creates the vacuum that is used to draw the liquid chemical solution into the water stream. The liquid chemical solution is mixed with the water stream inside the Venturi nozzle. FIG. 1 B shows a drawing of a Venturi Nozzle.

Part 2—Variable Area Orifice Control Valve (paragraphs [0028] through [0031])—The Venturi nozzle draws the liquid chemical solution into the water stream. However, some additional means must be employed to control the rate at which the liquid chemical solution is fed into the water stream. In the prior art designs, a variable area orifice is used to achieve this purpose of feed rate control.

Essentially, a variable area orifice is a restriction in the liquid chemical solution line that allows a fixed feed rate for a given restriction area (orifice area). The liquid chemical solution feed rate is adjusted by adjusting the orifice area. For conceptual purposes, FIG. 1C shows an example of a theoretical Orifice Area vs. Feed Rate curve. Real life curves are not straight lines, but this is not relevant to our discussion.

Note that the maximum feed rate will be determined by the design of the Venturi nozzle. The use of the variable area orifice allows feed rate control in the range from zero up to the maximum feed rate capacity allowed by the Venturi nozzle.

In its most common form, a manually adjustable knob is directly connected to V-Notch or Needle valve. The valve is threaded and by turning the knob, the valve is moved in and out of a seat thereby decreasing and increasing the orifice area (and therefore decreasing and increasing the liquid chemical feed rate). FIG. 1D shows a conceptual drawing of a manual Variable Area Orifice Control Valve.

Problems with Prior Art Systems—The prior art Vacuum Solution Feed Systems are limited in their ability to accurately and consistently control the feed rate of liquid chemical solutions. This is a result of the limitations of the Variable Area Orifice concept which often encounters serious difficulty when it is applied to the typical feed rates and liquid chemical solutions used in the municipal and industrial water treatment industries. These problems are outlined in paragraphs [0002] through [0007] of this specification. Paragraphs [0012] through [0024] explain how the V-RAD invention conceptually addresses these problems in detail. Paragraphs [0046] through [0078] outline how the V-RAD first prototype has been constructed to achieve these results.

Object of the Invention—To improve the Vacuum Solution Feed System (for liquid chemical solutions) so that it will achieve accurate and stable control of (liquid solution) feed rate. To accomplish this by replacing the Variable Area Orifice Control Valve with a new device that is designed to avoid the prior art feed rate control accuracy and stability limitations caused by hysteresis, mechanical instability, clogging by loose solids, and feed rate reduction caused by precipitation of solids. The V-RAD has been invented to serve this purpose.

Detailed Explanation of the V-RAD Invention—The V-RAD invention consists of the implementation of one or both of two general design concepts to achieve the objective stated above. These two concepts will continue to be referred to as Design Concept 1 and Design Concept 2 according to paragraphs [0010] and [0011]. FIG. 2A shows a typical vacuum solution feed system design using the V-RAD device.

Design Concept 2: The cycle is designed so that liquid solution flow direction through the orifice is reversed either during each cycle, in each consecutive cycle (as in the first V-RAD prototype device described in paragraphs [0046] through [0078]), or after any number of cycles has been completed to make it “self flushing”. Numerous methods of achieving this have been contemplated. One method will be outlined in detail below in the section of the DESCRIPTION OF THE PREFERRED EMBODIMENT paragraphs [0046] through [0078].

Design Concept 1: Feed rate control is achieved by periodically adjusting the orifice area in a cyclical manner. Feed rate is determined by the timing of the cycle as explained in detail below in paragraphs [0037] through [0045].

As explained in the discussion of the Variable Area Orifice Control Valve, each orifice area size corresponds to a given liquid chemical solution feed rate. (Assuming that viscosity, temperature, supply pressure, and Venturi Nozzle performance remain constant, then liquid chemical solution feed rate is determined by orifice area.) See FIG. 1C that shows a theoretical example of how feed rate is related to orifice area. However, as explained in paragraphs [0003] through [0007], due to several factors the use of a Variable Area Orifice Control Valve is not sufficiently accurate and stable for feed rate control in many applications for liquid chemical solution injection commonly encountered in municipal and industrial water treatment.

Several variations of the V-RAD invention have been contemplated. In paragraphs [0039] through [0045] we will outline Design Concept I in general terms. In the following DESCRIPTION OF THE PREFERRED EMBODIMENT section (paragraphs [0046] through [0078], we will outline one variation that has been employed to build the first V-RAD prototype device.

In general terms, Design Concept 1 employs a set of “orifice sizes” A1, A₂, A₃, A4, . . . Aₓ. A cycle referred to as the “period” P is continually repeated where a corresponding set of times will be spent at each orifice size T₁, T₂, T₃, T₄, . . . Tₓ. The time spent at each orifice size will be referred to as the “orifice time” hereafter.

Each time a Period is completed another will begin. In general, each of the orifice sizes (A₁-Aₓ) and each of the orifice times (T₁-Tₓ) is adjustable. P is therefore also adjustable in general.

For each installation (assuming all other conditions remain constant) each orifice size Aₓ, corresponds to a fixed “orifice feed rate” Qₓ (volume/time). For an example of one set of orifice sizes and the corresponding orifice feed rates used with the first V-RAD prototype device see FIG. 2B.

The sum of all of the orifice times constitutes one period P (time). FIG. 3A (Equation 1) mathematically defines the period in the general case of the V-RAD invention.

The volume of feed per period V_{P} (volume) is given by the sum of the products of the orifice times and the corresponding orifice feed rates. FIG. 3B (Equation 2) mathematically defines the volume of feed per period V_{P} in the general case of the V-RAD invention.

The V-RAD average feed rate F (volume/time) is given by the volume of feed per period divided by the period. FIG. 3C (Equation 3) mathematically defines the V-RAD average feed rate in the general case.

Since orifice feed rate Qᵢ is determined by Aᵢ, consideration of FIG. 3C (Equation 3) leads to the conclusion that average V-RAD feed rate F is controlled through the variables Aᵢ and Tᵢ. One method of implementing this concept has been selected for the design of the first V-RAD prototype device that will be described in the following section titled DESCRIPTION OF THE PREFERRED EMBODIMENT in paragraphs [0046] through [0078].

### DESCRPTION OF THE PREFERRED EMBODIMENT

Background—Paragraphs [0046] through [0078] will describe one embodiment of the V-RAD design invention that has been implemented in the fabrication by the inventors of the first V-RAD device. This V-RAD device has been constructed and tested. In the following discussion, this particular design will be referred to as the “V-RAD” or “the first V-RAD prototype”.

Design Explanation (paragraphs [0047] through [0078])—The V-RAD has been constructed by using a valve stem with a fixed orifice and a valve seat with a cross hole. See FIG. 2C. The valve stem is a shaft with a machined feature perpendicular to its axis. The feature is symmetrical from the axis to the outside diameter of the stem shaft. The feature consists of an orifice at the shaft axis and two larger pockets on either side of the orifice. The seat and shaft mating diameters and materials are such that unless the cross hole features are aligned, they will create a seal. (The arrangement depicted in FIG. 2D represents the V-RAD device that will be discussed below. The valve stem machined feature consists of two blind drill holes 0.1875″ in diameter joined by an orifice through hole 0.015″ in diameter. This gives a 12.5:1 ratio of the pocket diameter to the orifice diameter. The valve seat cross hole for feed is 0.125″ in diameter.)

The valve stem is automatically rotated with a stepper motor driven by a microprocessor controller. A motion control system is incorporated that will identify the position of the shaft relative to the seat at 0°, 90°, 180°, and 270° degrees. For our discussion, we will designate that at 0° and 180° the shaft orifice feature is aligned with the seat cross hole and at 90° and 270° the shaft orifice feature is perpendicular to the seat cross hole.

The valve stem is then rotated in one direction indefinitely, but stopping each time it travels 90° and waiting for the appropriate orifice time to expire. NOTE: Changing the direction of rotation after one or more periods have past has been considered and may be implemented.

Using the general terminology outlined in the detailed explanation of the V-RAD invention in paragraphs [0025] through [0045], the first V-RAD prototype is described as follows:

Design Concept 1 (paragraphs [0036] through [0045]) The first V-RAD prototype implementation of Design Concept 1 will be described clearly in paragraphs [0051] through [0058]. The V-RAD first prototype uses only two fixed area values A₁ and A₂. Therefore it uses two corresponding orifice times T₁ and T₂.

In this discussion, the first orifice area that corresponds to the 90° and 270° positions will be designated as A₁. At these two positions the valve orifice is perpendicular to the valve seat cross hole and the valve is sealed closed. Therefore, A₁=0. In this position, with the orifice area zero, the feed rate is zero (Q₁=0). The orifice time for these positions will be designated as T₁.

The orifice area of the valve stem through hole will be designated as A₂. This corresponds to the 0° and 180°, positions where the orifice feature in the stem is aligned with the cross hole in the seat. The orifice Area A₂ is fixed in this design, but different orifice sizes can be made to access different feed rate ranges. In our discussion, we will describe an orifice made by a 0.015″ diameter round hole that allows a feed rate of approximately Q₂=1.5 gallons/hour (gph) of water. The orifice time for these positions will be designated as T₂.

The orifice times T₁ and T₂ are adjusted to set the average V-RAD feed rate F. After consideration of FIG. 3C (Equation 3) it can be concluded that the average V-RAD feed rate range is zero to Q₂(0<F<Q₂). In the case of the orifice A₂ using a 0.015″ diameter hole, the range is zero to 1.5 gallons per hour (0<F<1.5 gph). Also from FIG. 3C (Equation 3), since Q₁=0 and all other Qᵢ=0, Equation 4 shown in FIG. 3D can be derived as the formula determining average V-RAD feed rate in the special case of the first prototype V-RAD design.

Feed Rate Control—As shown in FIG. 3D (Equation 4), the feed rate is determined by the percentage of the time of the period P spent at orifice time T₂ multiplied by the feed rate of the orifice Q₂. Considering that the period is the sum of the orifice times (P=T₁+T₂), the V-RAD first prototype has been designed to allow feed rate control covering the range of zero to Q₂ (0<F<Q₂) by (setting P=constant and) adjusting T₂ in the range of zero to P (0<T₂<P).

The value of T₂ (and therefore of F) can be adjusted by either manual adjustment of a potentiometer dial, Analog input signal to the microprocessor controller (such as a 4-20 mA input), or Digital input signal to the microprocessor controller.

Control method note: In the method of paragraphs [0055] and [0056] it is expected that both the period P and orifice time T₂ will be adjustable while T₁ will be determined as the result of the period P minus the orifice time T₂ (P−T₂=T₁).

Alternate control method: Clearly the alternate method of adjusting the orifice times T₁ and T₂ could be used. This has also been implemented and tested by the inventors.

Design Concept 2 (paragraph [0035])—Since the valve stem is continually rotated in one direction, Design Concept 2 is implemented because the flow direction through the orifice is reversed every Period (P=T₁+T₂) with every 180° motion of the valve stem. Specifically, the flow direction through the orifice is reversed on each consecutive cycle.

Positional Indication System—Refer to FIG. 2D for this discussion. The method described in paragraphs [0060] through [0063] has been designed by the inventors and implemented in the first V-RAD prototype to determine the rotational position of the valve stem relative to the valve seat at the 0°, 90°, 180°, and 270° positions.

A disk (hereafter referred to as the window disk) is directly coupled to the valve stem shaft. The window disk has a 2.500″ outside diameter with a single 0.250″ diameter through hole at a radius of 1.000″. The window disk is mounted rigidly to the valve stem shaft so that the 0.250″ diameter through hole is aligned with the axis of the orifice feature of the valve stem.

The window disk is mounted less than 0.125″ apart from a coplanar circuit board that we will refer to as the sensor board. The sensor board includes four light sensors equally spaced at 90° around a circle of 1.000″ radius. The sensor board is rigidly coupled to the valve seat and orientated so that the four sensors are aligned parallel and perpendicular to the valve seat cross hole.

Using this scheme the sensor board gives an indication of when the window disk 0.250″ through hole (and therefore the valve stem port) is aligned with one of the sensors. Therefore, it provides an indication each time that one side of the valve stem port is at 0°, 90°, 180°, and 270° relative to the valve seat cross hole.

Motion Control System—FIG. 2D also depicts the mechanical assembly comprising the first V-RAD prototype. The V-RAD shaft is turned using a rotary stepper motor that is driven by a microprocessor controller. Many additional options and features can be implemented in the controller design, but the portion that relates to the V-RAD invention is to turn the valve stem shaft until it receives the next sensor indication from the sensor board and then wait for the prescribed orifice time T₁ or T₂ depending on the position designation.

Generally the direction may be reversed after a set number of periods have been completed, but in our discussion we will assume that it will only rotate in one direction.

NOTE: The microprocessor controller will be programmed to move to the next closed position (90° or 270°) and remain there, when it is either automatically or manually set to zero or turned off. The water supply to the Venturi nozzle is normally stopped in other vacuum solution feed systems, but this provides and additional method to prevent the unwanted feed of the liquid chemical solution when the system is intended to be off.

Period Setting Considerations—The value of the Period P is intended to be adjustable to allow for optimization among the following considerations that will vary depending on the parameters of each installation. Based on the below considerations, we anticipate that an optimal value of the period P will typically be in the range of 5 seconds to 60 seconds. The following three major considerations (discussed in paragraphs [0068] through [0072]) should be balanced when determining an optimal setting for the Period P.

#1 Design Concept 2 (paragraph [0035])—In the extreme case of very high period setting (the limit of P=∞) the flow direction is never reversed because the valve never moves. Certainly, as the value of P is reduced the action of flow reversal is more frequent and more beneficial for avoiding clogging and precipitation. However, as the period P approaches zero, a practical low limit will be reached, because the valve will never stop and feed rate control will eventually become unreliable or impossible. From our experiments with the 0.015″ diameter orifice, we are finding that P should remain greater than about 5 seconds because of this consideration. Of course, for this same reason the values of T₁ and T₂ will both have practical lower limits. Therefore, as the value of the period P is reduced, it can be seen that less of the theoretical feed rate range can be accessed. However, with this lower limit kept in mind, it would be best for this consideration to minimize the value of P in order to maximize the anti-clogging effects of Design Concept 2.

#2 Mechanical Wear—In order to maximize the life of the valve stem shaft, valve seat, shaft seal, motor and all other mechanical parts, it would be preferable to increase the value of the period P as much as possible. This can be thought of in terms of valve stem shaft revolutions per unit time. For example, if the value of the period P is set to 15 seconds, then the valve stem shaft will rotate just over 1 million times in one year of continuous operation. Long-term experimentation will need to be done to characterize this consideration further. FIG. 2G shows the relation between revolutions per year and the value of P.

#3 Smooth Chemical Injection (paragraphs [0070] through [0072]—The V-RAD is being used to control the injection of a liquid chemical solution into a water stream inside the Venturi nozzle. The injection rate into the water stream should be sufficiently constant that the chemical is able to evenly distribute itself in the receiving water. In the case of injection into a water tank, this is less of a concern. However, when the injection is into a pipe with moving water, consideration must be taken to avoid a situation where the pulses are separated in time so much that the treated water pipe will result in a wave pattern of the chemical concentration that is not quickly mixed by diffusion. FIG. 2F shows a graphical representation of this scenario.

As can be seen from FIG. 2E, the liquid chemical solution passes through the V-RAD device in pulses in time. However, from a consideration of FIG. 2F, it can be seen that the pulses will be dampened in the vacuum line between the V-RAD and the Venturi nozzle and then again in the solution line between the Venturi nozzle and the injection point.

Also, consider that as the percentage of the Period time spent at the orifice time T₂, is reduced, this consideration becomes more significant. Therefore, the lowest setting of T₂ should be considered when considering this point to determine P. FIG. 2F gives a conceptual view of the potential pulse widths and separation. Clearly, this is an important point to consider in setting the value of P and clearly it sets an upper limit for P. For this consideration, minimization of P is clearly preferred, but the numerical effect will vary from installation to installation.

Additional Design Features—Paragraphs [0074] through [0078] discuss additional design features of the V-RAD first prototype.

#1 Relief Port (paragraphs [0074] through [0076]—Some liquid chemical solutions commonly encountered in the field of municipal and industrial water treatment are often very near the evaporation points at standard conditions. For example, Sodium Hypochlorite solution evaporates relatively quickly even at moderate Temperature. Therefore, a relief port must be incorporated into the design to prevent evaporation from causing pressure build up when the orifice feature in the valve stem is not aligned with the valve seat cross hole.

To accomplish this, a series of features must be machined into the valve seat so that when it rests at 90° or 180° positions the valve stem orifice cavity is open to either the upstream or downstream V-RAD connection port.

In the V-RAD first prototype, we have designed the valve seat so that this cavity is connected to either port. However, our intention is that the downstream port (Venturi nozzle side) would be preferable because the trapped liquid is drawn out under vacuum.

#2 Shaft Seal—A consideration of the design and the installation requirement that the V-RAD be capable of continuous 24-hour operation indicates that the valve stem shaft will typically experience on the order of 10⁶ revolutions per year. Minimal down time and maintenance are a primary concern. Therefore, all parts must be designed to withstand at least 10⁶ revolutions preferably without maintenance. A shaft seal designed for maximum endurance must be used. The V-RAD first prototype incorporates a state of the art rotary shaft seal selected based on the expected operating conditions.

#3 Flooded Suction Considerations—The V-RAD device does not require flooded suction, but it can be used. Also, because this is a vacuum system, there is a limit to the maximum lift height that is determined by the maximum vacuum level (−1 atmosphere) that can be created and the hydrostatic pressure. For liquid chemical solution with a specific gravity of 1.0 this yields a theoretical maximum lift height of 34.4 feet (for sp=1.2 this falls to 28.7 feet). In reality, the reliable maximum lift height is perhaps 10 feet less than these numbers suggest. Another consideration is that using flooded suction could in some cases improve feed rate consistency by reducing the amount of vapor pockets inside the suction line.

1. The first V-RAD device (described in paragraphs [0046] through [0078]) is a new and uniquely designed invention for the application of feed rate control of liquid chemical solutions in vacuum solution feed systems operated by a Venturi nozzle or any other vacuum source.

2. The V-RAD invention includes any liquid chemical solution feed rate control device, designed using Design Concept 1, Design Concept 2, or both (as described in paragraphs [0034] through [0045]), to be used in a vacuum solution feed system operated by a Venturi nozzle or any other vacuum source.
